(19) United States
(12) Patent Application Publication
(10) Pub. No.: US 2008/0017811 A1
(43) Pub. Date: Jan. 24, 2008

(54) Beam stop for an ion implanter

(76) Inventors: Erik J.H. Collart, West Sussex (GB); Richard David Goldberg, Boston, MA (US); Christopher J.S. Burgess, East Sussex (GB)

Correspondence Address: APPLIED MATERIALS, INC., P. O. BOX 450A, SANTA CLARA, CA, 95052, US

(21) Appl. No.: 11/812,358

(22) Filed: Jun. 18, 2007

Related U.S. Application Data
(60) Provisional application No. 60/831,465, filed on Jul. 18, 2006.

(51) Int. Cl. G21K 5/00

(52) U.S. Cl. 250/492.21

(57) ABSTRACT

This invention relates to a beam stop for an ion implanter that provides a measure of the ion beam current incident thereon and that may be used for ion beam optimisation. A beam stop for an ion implanter is provided comprising a charge collector with a segmented surface provided to receive an ion beam thereon, wherein the surface is divided into at least two segments, one segment extending around the other segment, and wherein each of the two segments is operable to provide one or more signals indicative of charge collected by that segment when an ion beam is incident thereon. Such a beam stop is advantageous as it provides information on the ion beam profile without the need to scan the ion beam.

### FIELD OF THE INVENTION

This invention relates to a beam stop for an ion implanter, to an ion implanter having such a beam stop and to a method of ion implantation. In particular, although not exclusively, the present invention relates to a beam stop that provides a measure of the ion beam current incident thereon and that may be used for ion beam optimisation.

### BACKGROUND OF THE INVENTION

Ion implanters are well known and generally conform to a common design as follows. An ion source produces a mixed beam of ions from a precursor gas or the like. Only ions of a particular species are usually required for implantation in a substrate, for example a particular dopant for implantation in a semiconductor wafer. The required ions are selected from the mixed ion beam using a mass-analysing magnet in association with a mass-resolving slit. Hence, an ion beam containing almost exclusively the required ion species emerges from the mass-resolving slit to be transported to a process chamber where the ion beam is incident on a substrate held in place in the ion beam path by a substrate holder. A beam stop is provided to receive the ion beam when the substrate is moved out of the way of the ion beam.

It is often desirable to measure the flux and/or cross-sectional profile of an ion beam in an ion implanter in order to improve control of the implantation process. One example where such a desire exists is in ion implanters where the ion beam size is smaller than the substrate to be implanted. In order to ensure ion implantation across the whole of the substrate, the ion beam and substrate are moved relative to one another such that the ion beam scans the entire substrate surface. This may be achieved by (a) deflecting the ion beam to scan across the substrate that is held in a fixed position, (b) mechanically moving the substrate whilst keeping the ion beam path fixed or (c) a combination of deflecting the ion beam and moving the substrate. Generally, relative motion is effected such that the ion beam traces a raster pattern on the substrate.

Our co-pending U.S. patent application Ser. No. 10/119,290 describes an ion implanter of the general design described above. A single substrate is held in a moveable substrate holder. Ion optics are provided that allow some steering and shaping of the ion beam. However, the implanter is operated such that ion beam follows a fixed path during implantation and the substrate holder is moved along two orthogonal axes to cause the ion beam to scan over the substrate following a raster pattern.

U.S. Pat. No. 6,525,327 describes an ion implanter where the beam stop is used to measure the ion beam. The beam stop comprises three linearly-extending, charge-collecting rods. Each of the rods provides a signal indicative of the ion beam current incident thereon. The signals may be compared to effect ion beam centring. U.S. Pat. No. 6,525,327 also discloses dividing a collecting plate of the beam stop in the same direction as the linearly-extending rods. Signals from the different parts of the divided plate can also be used for ion beam centring.

### SUMMARY OF THE INVENTION

Against this background, and from a first aspect, the present invention resides in a beam stop for an ion implanter comprising a charge collector with a segmented surface provided to receive an ion beam thereon, wherein the surface is divided into at least two segments, one segment extending around the other segment, and wherein each of the two segments is operable to provide one or more signals indicative of charge collected by that segment when an ion beam is incident thereon.

Such a beam stop is advantageous as it provides information on the ion beam profile without the need to scan the ion beam. Various arrangements are possible, such as dividing the surface into at least two concentrically arranged segments that may include an annular segment that, optionally, extends around a central circular segment. Such an arrangement is useful as it conveniently provides a radial profile of the ion beam. One or more annular segments may be used. A series of concentrically arranged annular segments surrounding a central circular segment will provide more information on the radial profile and hence allow it to be determined with a greater resolution. However, processing the larger number of signals from each segment means that often a compromise must be reached.

The relative areas of the segments may be varied. Possible schemes include using segments that have equal areas, increasing linearly the diameter of each segment, or using different areas for each segment.

Preferably, one or more segments are further divided laterally and wherein each of the parts of the segment is operable to provide a signal indicative of charge collected by that part. Thus, a segment may be divided into sub-units, referred to herein as parts. A segment comprises a collection of parts that, as a whole, extend around another segment, e.g. a series of sectors of an annulus. Each part provides its own signal that may be summed to provide the total charge collected by the segment. Dividing the segment into parts allows more useful information to be collected. In a contemplated embodiment, a segment is divided laterally into halves. The division may be made transverse to a scanning direction to allow centring of an ion beam, for example by equalising the charge collected on each half of the segment. It is envisaged that exact equalising may not be optimal: compensating for unequal detector responses from the two halves may be required.

A further envisaged lateral division of a segment is into quarters. Again, this may optionally see the segment divided transverse to the scanning directions to allow centring in both scan directions. This may be effected by summing the signals from neighbouring pairs of quarters and comparing the two signals. For horizontal scanning, vertically aligned pairs are summed and vice versa.

From a second aspect, the present invention resides in an ion implanter including any of the beam stops described above. Optionally, the surface of the charge collector is divided into at least two concentrically arranged segments and wherein the ion implanter is operable to provide an ion beam having a shape corresponding to that of the segments when taken together.

Where the ion implanter further comprises a substrate holder for holding a substrate to be implanted in the ion beam's path upstream of the beam stop and is operable to cause relative motion of the ion beam and the substrate holder along a first direction, it is preferred that one or more segments of the beam stop are further divided transverse to the first direction with each of the halves so formed being operable to provide a signal indicative of charge collected by that half. Likewise, quarters may be used where there are two scanning directions.

From a third aspect, the present invention resides in a method of optimising an ion beam in any of the ion implanters described above, comprising shaping and/or steering the ion beam in response to signals provided by the segments of the beam stop.

From a fourth aspect, the present invention resides in a beam stop for an ion implanter comprising a front face defining an entrance aperture, an internal volume extending from the entrance aperture bounded by one or more sides and a back face, a charge collector with a surface forming at least part of the back face and being provided to receive an ion beam thereon, and a charge collecting baffle extending into the internal volume from one of the one or more sides and positioned upstream of the back face to present a forward face provided to receive an ion beam thereon, wherein the charge collector and the charge collecting baffle are each operable to provide one or more signals indicative of charge collected when an ion beam is incident on the surface and forward face respectively.

This allows an ion beam profile to be collected from positions offset along the ion beam's path and so may provide other useful information such as the path of the ion beam along the z axis and divergence of the ion beam. A useful synergy may be realised by providing a back face to the baffle for collecting backscattered ions. Thus, one structural feature provides two functions: mitigation of the effects of backscattered ions and the possibility of ion beam path/divergence determination.

Optionally, the baffle extends inwardly an equal distance from each of the one or more sides thereby forming an aperture of corresponding shape to the entrance aperture. For example, the baffle may be annular in cross-section. Alternatively, separate baffles may be used. Two contemplated embodiments are a pair of baffles disposed symmetrically across the internal volume and four baffles disposed symmetrically around the internal volume.

The present invention also resides in an ion implanter including the beam stops described immediately above. In addition, the present invention also resides in a method of optimising an ion beam comprising shaping and/or steering the ion beam in response to signals provided by the charge collector and the charge collecting baffle.

Other preferred features are defined in the appended claims.

### BRIEF DESCRIPTION OF THE DRAWINGS

Embodiments of the invention will now be described with reference to the accompanying drawings, by way of example only, in which:

FIG. 1 is a schematic representation of an ion implanter;

FIG. 2 is a section through a beam stop according to embodiments of the present invention;

FIG. 3 is a front view of a first embodiment of a beam stop according to the present invention of FIG. 2;

FIG. 4 is a front view of a beam stop according to a second embodiment of the present invention;

FIG. 5 is a front view of a beam stop according to a third embodiment of the present invention;

FIG. 6 is a front view of a beam stop according to a fourth embodiment of the present invention;

FIG. 7 is a front view of a beam stop according to a fifth embodiment of the present invention;

FIG. 8 is a front view of a beam stop according to a sixth embodiment of the present invention;

FIG. 9 is a section through a beam stop according to further embodiments of the present invention;

FIG. 10 is a simplified section of the beam stop of FIG. 9 showing an incident high-energy ion beam;

FIG. 11 is a simplified section of the beam stop of FIG. 9 showing an incident low-energy ion beam;

FIG. 12 is a front view of a beam stop according to a seventh embodiment of the present invention; and

FIG. 13 is a front view of a beam stop according to an eighth embodiment of the present invention.

### DETAILED DESCRIPTION OF THE INVENTION

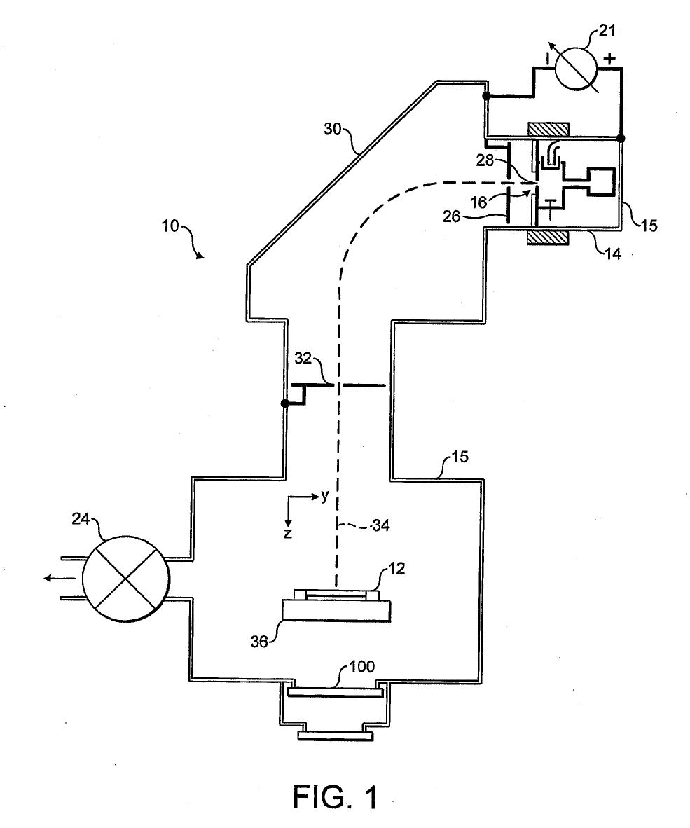

In order to provide a context for the present invention, an exemplary application is shown in FIG. 1, although it will be appreciated that this is merely an example and is in no way limiting.

FIG. 1 shows an ion implanter 10 for implanting ions in a semiconductor wafer 12. The ion implanter 10 is located within a vacuum chamber 15 pumped by vacuum pump 24. In summary, ions are generated by ion source 14 to be extracted and passed through a mass analysis stage 30. Ions of a desired mass are selected by passing through a mass-resolving slit 32, and continue to strike the semiconductor wafer 12. The ion implanter 10 is operated under the management of a controller, most often a computer operating suitable software.

The ion source 14 generates an ion beam that includes a desired species. Ions generated in the ion source 14 are extracted through an exit aperture 28 using an extraction electrode assembly 26. A potential difference is applied between the ion source 14 and the extraction electrode assembly (not shown) by a power supply 21 to accelerate extracted ions to a desired beam energy suitable for transit through the ion implanter 10, the ion source 14 and mass analysis stage 30 being electrically isolated from each other by an insulator (not shown). For shallow implants, this beam energy is optimised to be high enough to avoid unacceptable blow up in the beam caused by space charge effects, and the ion beam is later decelerated prior to implantation by a deceleration lens assembly (not shown).

The mixture of extracted ions pass through the mass analysis stage 30 so that they traverse a curved path under the influence of a magnetic field. The radius of curvature traveled by any ion is determined by its mass, charge state and energy. The magnetic field is controlled so that, for a set beam energy, only those ions with a desired mass and charge state exit along a path coincident with the mass-resolving slit 32. The emergent ion beam 34 is then transported to the target, i.e. the substrate wafer 12 to be implanted held in position by a wafer holder 36. When the wafer 12 and wafer holder 36 are moved out of the path of the ion beam 34, the ion beam 34 instead continues to be incident on the beam stop 100. The beam stop 100 absorbs the heat generated by incidence of the ion beam 34 and mitigates ejection of contaminants towards the wafer 12 caused by incidence of the ion beam 34.

Either a single semiconductor wafer 12 (or other target) may be implanted at a time or many wafers 12 may be positioned on a carousel or the like that rotates to present the wafers 12 to the incident ion beam in turn.

Implantation is generally effected by scanning the ion beam 34 relative to the wafer 12 such that a required dose is achieved after many passes. Scanning may be achieved by movement of the wafer 12 using the wafer holder 36, movement of the ion beam 34 using ion optics (not shown) or a combination of the two.

The geometry in the region around the wafer 12 is indicated by axes in FIG. 1. The z axis corresponds to the direction of travel of the ion beam 34. The x axis is taken to be the horizontal, and the y axis is taken to be the vertical.

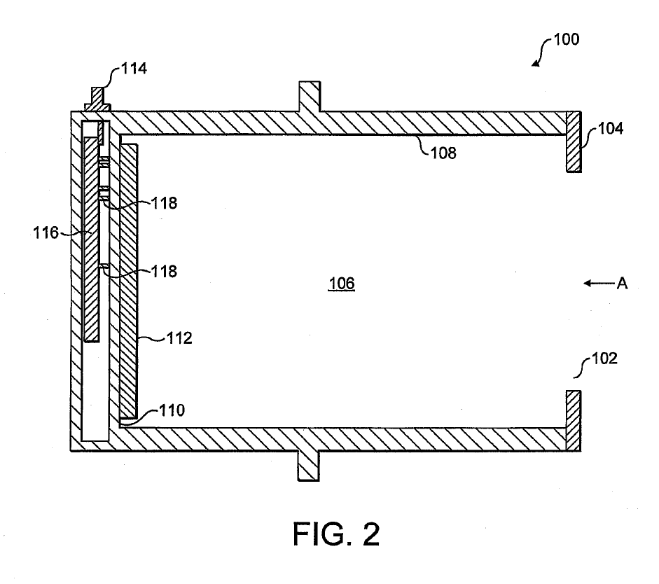

A beam stop 100 according to embodiments of the present invention is shown in section in FIG. 2. The beam stop 100 comprises a Faraday cup having an entrance aperture 102 defined by an annular collar 104 such that the aperture 102 is sufficiently wide to accept the ion beam 34. In this embodiment, the wafer 12 is scanned relative to a fixed ion beam 34. This means only small movement of the ion beam 34 is effected (effectively to correct and optimise beam shape and position) and so the aperture 102 may be correspondingly small. A larger aperture 102 would be required where the ion beam 34 is scanned during implantation. In a hybrid scanning implanter 10, one dimension of the aperture 102 is likely to be far wider than the other.

The beam stop 100 defines an internal volume 106 that extends from the entrance aperture 102 and is bounded by a side wall 108 and a back wall 110. A back plate 112 is attached to the back wall 110 in standard fashion, so as to face the entrance aperture 102. Thus, an ion beam 34 travelling as indicated by arrow A enters through the entrance aperture 102 and strikes the back plate 112. The back plate 112 is insulated from the rest of the beam stop 100 and is sized such that it covers the full extent of the ion beam 34.

The side wall 108 is optimised, or has an associated liner that is optimised, to absorb secondary electrons and other charged particles liberated from the back plate 112 by ion bombardment. The collar 104 defining the entrance aperture 102 may be similarly treated to ensure optimised absorption of ejected charged particles. A magnetic field, provided by permanent magnets or the like (not shown), may be provided across the entrance aperture 102 to suppress loss of charged particles from the beam stop 100 that might otherwise contaminate the wafer 12. The field also suppresses external electrons from entering the beam stop 100 and guides any higher-energy electrons to the side wall 108 rather than allowing them to reach the back plate 112 and provide a false reading. Thus, the back plate 112 provides an accurate measure of ions in the ion beam 34.

The back plate 112 generates a signal that is proportional to the incident ion beam current, as is well known in the art. This signal may be taken directly from the back plate 112 via an electrical connection 114. Alternatively, the signal may pass through preliminary signal processing in the beam stop 100, for example by circuit 116 shown in FIG. 2. The signal taken from the connection 114 is passed to the ion implanter controller.

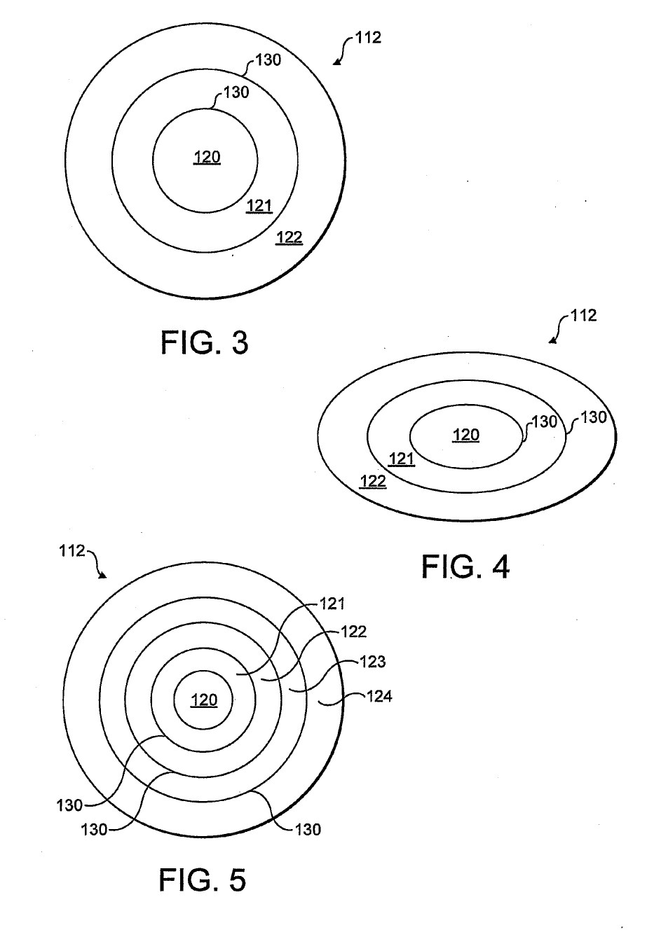

FIG. 3 shows a front view of a first embodiment of a back plate 112. The back plate 112 has a circular cross-section and comprises a circular centre segment 110 surrounded by two annular segments 121 and 122, the segments 120 to 122 being separated by small gaps 130. The three segments 120 to 122 are arranged concentrically, and have equal areas in this embodiment. Each segment 120 to 122 is electrically isolated from the other two segments. A connection 118, such as those shown in FIG. 2, is provided to each segment 120 to 122 such that each segment 120 to 122 provides a signal indicative of the ion beam current incident thereon.

These signals may be used to derive information about the ion beam 34. For example, the signals may be represented as a histogram to indicate how the ion beam current decreases as a function of radial distance from the centre of the ion beam 34. As a wafer 12 is implanted by scanning along overlapping scan lines, it is important to know the radial profile of the ion beam 34. This includes both the width of the ion beam 34 and also the radial variation of the ion beam current. For example, the ion beam current may be characterised as a Gaussian. Also, knowledge of any asymmetries in the ion beam 34 is useful as they may then be corrected or compensated. Of course, total ion beam current can be found simply by summing the signals from the three segments 120 to 122.

FIG. 3 shows a circular back plate 112 with circular segments 120 to 122 that is best suited to characterising ion beams 34 with circular profiles. However, the ion beam 34 may not necessarily be circular, and the shape of the back plate 112 and its segments 120 to 122 may be altered accordingly. For example, FIG. 4 shows a back plate 112 that is identical to the back plate 112 of FIG. 2, other than that it has an elliptical shape to suit an elliptical ion beam. Thus, the back plate 112 is divided into an elliptical centre segment 120 surrounded by elliptical annular segments 121 and 122.

The number of segments 120 to 122 may be varied depending upon the amount of information required. FIG. 5 shows a circular back plate 112 divided into a circular centre segment 120 surrounded by four annular sections 121 to 124. Of course, any number of segments 121 to 124 may be chosen. Generally, the choice of segments 121 to 124 will be a compromise between the benefit of additional information and the penalty of more signal processing.

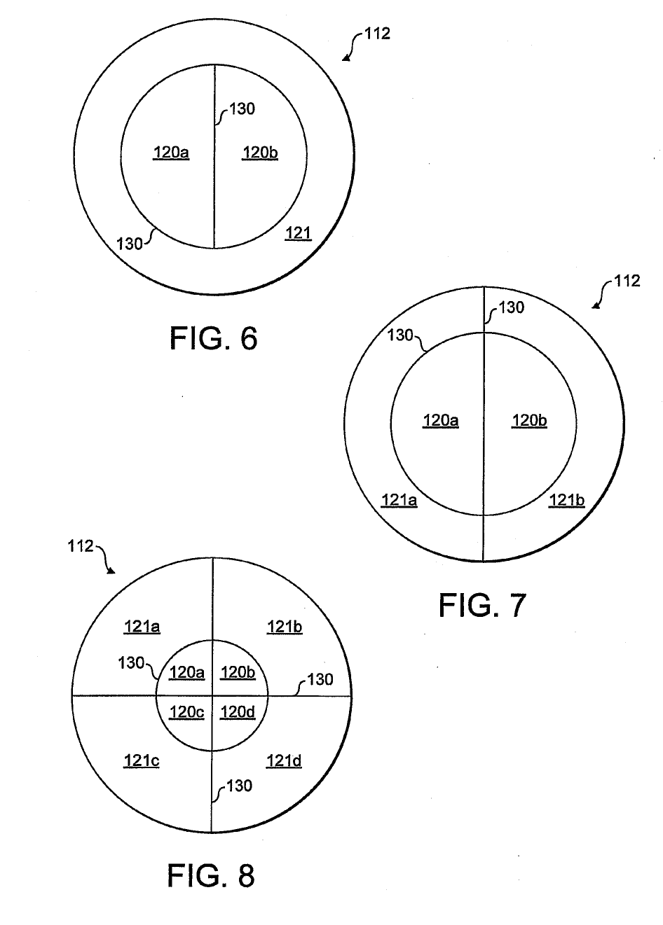

In addition to providing radial information on the ion beam profile, the back stop 100 can be used to provide centring information. This is most useful when performed with respect to the scanning directions, i.e. to provide centring information along the x and y axes in this embodiment. FIG. 6 shows an embodiment of a circular back plate 112 divided into two segments 120 and 121: a circular inner segment 120 and an annular outer segment 121. The inner segment 120 is further divided into two halves 120a and 120b by a vertical, electrically insulating gap 130. Each of the two halves 121a and 121b provides its own signal that is indicative of the ion beam current thereon.

Thus, the back plate 112 of FIG. 6 provides three signals. The two signals from the two halves 120a, 120b of the inner segment 120 may be compared to determine the centring of the ion beam 34 along the x axis. The measurements may be performed as the ion beam 34 is adjusted, i.e. use the measurements in a feedback loop to control steering of the ion beam 34. To centre the ion beam 34 on the beam stop 100, the signals from the two halves 120a and 120b should be equalised (assuming the response from each half 120a, 120b to be the same: the back plate 112 may be calibrated and differences in sensitivity compensated accordingly). Alternatively, the optimum ion beam position may not correspond to the centre of the beam stop 100, and so the ion beam 34 may be adjusted until a required offset is achieved between the segment halves 120a and 120b.

The signals from the two halves 120a and 120b of the inner segment 120 may be summed and compared to the signal from the outer segment 121 (or outer segments, where more than one are present) to allow radial profiling, as described previously.

FIG. 7 shows a variation of the embodiment of FIG. 6 where both inner and outer segments 120, 121 are divided into two halves. In addition to the centring and radial profiling already described, further analysis may be performed by comparing the radial profile of the left and right halves of the ion beam 34. Thus any asymmetries in the ion beam 34 may be detected, and also monitored during correctional reshaping of the ion beam 34 using the ion optics of the ion implanter 10.

FIG. 8 builds on the embodiment of FIG. 7 by further dividing the inner and outer segments 120, 121 with a horizontally extending gap 130. Thus the inner and outer segments 120, 121 are both divided into quarters, with each quarter providing its own signal (making eight in total). Thus, the back plate of FIG. 8 may be used to centre the ion beam 34 in both the x- and y-axis directions and also to detect asymmetries in both the x- and y-axis directions. It will be appreciated that this is achieved by summing adjacent quarters and comparing against the corresponding pair, e.g. 120a and 120c can be summed and compared with the sum of 120b and 120d to obtain x-axis centring.

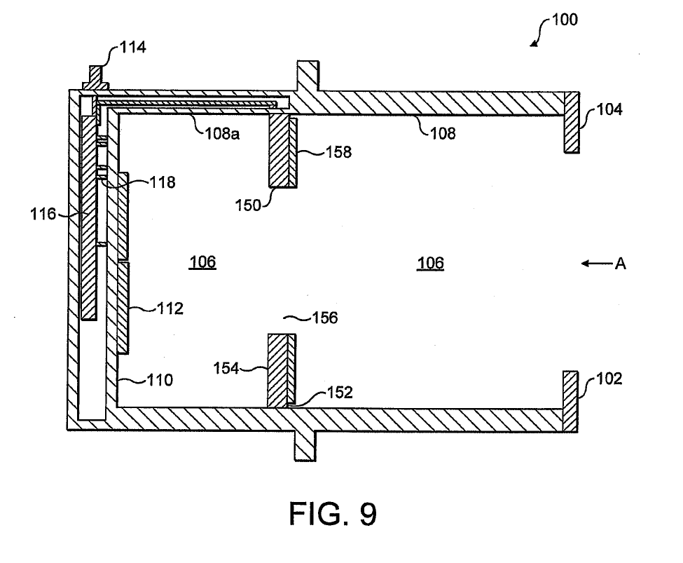

FIG. 9 shows a beam stop 100 in section that broadly corresponds to that of FIG. 2. Accordingly, like reference numerals are used for like parts. In order to reduce further any problems associated with ejection of charged particles from the back plate 112, a baffle 150 is provided part way along the internal volume 106. Alternatively, two or more separate baffles 150 may be provided. The baffle 150 projects inwardly from the side wall 108 and presents a front face 152 (closest to the entrance aperture 102) and a back face 154. The back face 154 is optimised for absorbing ejected secondary electrons and other charged particles.

The baffle 150 forms a neck 156 in the internal volume 106 with a narrow bore such that many of the charged particles ejected from the back plate 112 are absorbed by the baffle 150 or the section of side wall 108a between the baffle 150 and back wall 110.

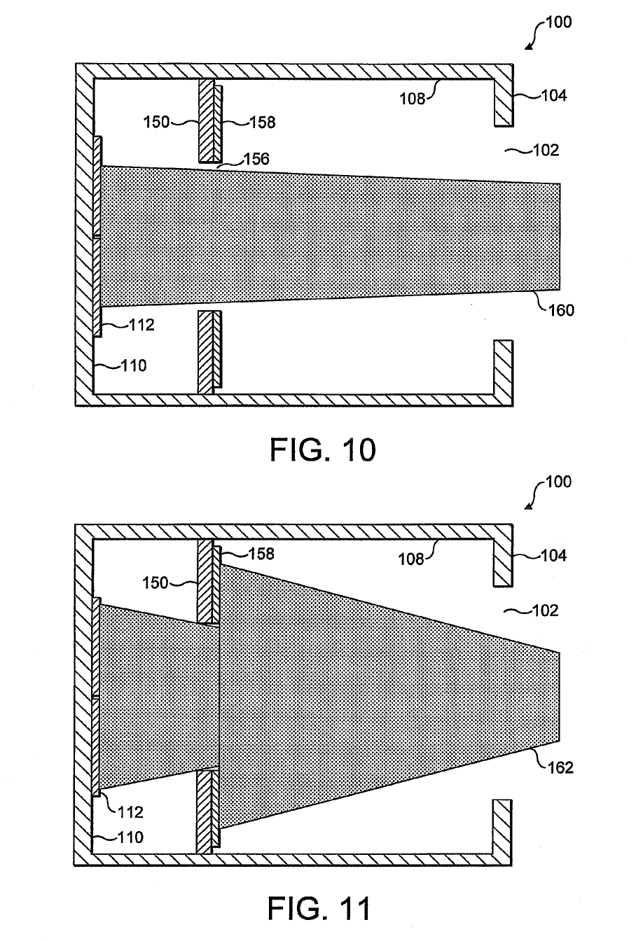

FIGS. 10 and 11 show a high-energy 160 and low-energy 162 ion beam respectively travelling through the beam stop 100. Divergence is less in the high-energy ion beam 160 where space charge effects have less time to act. Accordingly, the high-energy ion beam 160 is narrower and passes through both the entrance aperture 102 and the narrower bore 156 defined by the annular baffle 150. The blow-up of the low-energy ion beam 162 results in the edge of the ion beam 162 clipping the baffle 150. Accordingly, the baffle 150 creates a shadow downstream, although continued divergence of the ion beam 162 reduces the shadow size. As it is only the edges of the ion beam 162 that clip the baffle 150 where there is very little current, the problem of charged particle ejection is very much reduced compared to that from the back plate 112.

However, it is advantageous to measure the ion beam current incident on the baffle 150 to allow total ion beam current measurement and radial profiling. Moreover, the fact that the baffle 150 is offset along the z axis allows the ion beam trajectory and divergence to be measured. Thus the front face 152 of the baffle 150 is provided with a charge collecting plate 158 (hereinafter referred to as a baffle plate) from which a signal is provided that is indicative of the ion beam current incident thereon.

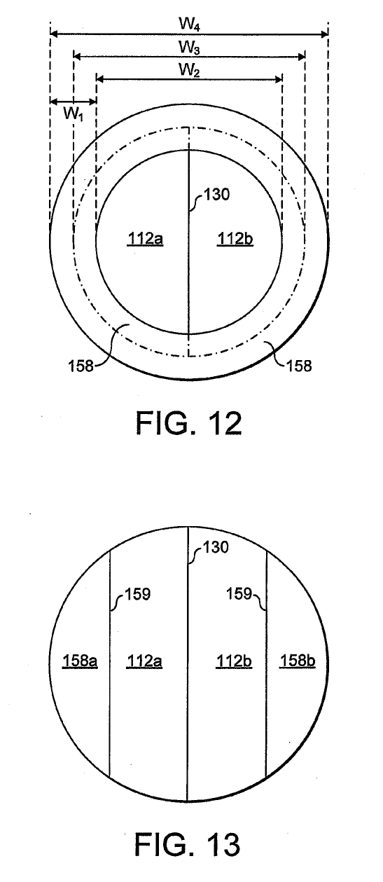

As the neck 156 formed by the baffle 150 is narrower than the entrance aperture 102, the back plate 112 may be smaller than those previously described. Although a single-piece back plate 112 may be used, it is preferred to use segmented back plates 112. FIGS. 12 and 13 show two such arrangements.

FIG. 12 is a front view of one embodiment of a vertically-divided back plate 112 with an annular baffle plate 158. The annular baffle plate 158 has a width W₁, and defines an aperture 156 of width W₂. The back plate 112 is circular and has a width W₃. W₃ is smaller than the overall width W₄ of the internal volume 106, but larger than W₂ to account for divergence of the ion beam 34. Again, total ion beam current may be found by summing all signals.

FIG. 13 is a front view of another embodiment of a beam stop 100 with baffles 158. The baffles 158 comprise two corresponding segments 158a and 158b (in the mathematical sense, i.e. they correspond to the area between an arc and chord of a circle, the arc formed by the side wall and the chord formed by a parallel edge). The edges 159 run vertically, as does the gap 130 that divides a circular back plate 112 into two halves 112a and 112b. As before, the back plate 112 can be used to centre the ion beam 34 in the x-axis direction. In addition, so too can the baffle plates 158a and 158b. Summing the signals from the baffle plates 158a and 158b and the back plate 112 provides the total ion beam current.

The baffles 158 of FIGS. 9 to 13 may be combined with the annular segmented back plate 112 of FIGS. 3 to 8. In particular, combining the annular baffle plate 158 of FIG. 12 with the annular segment back plate 112 is useful as it allows the trajectory and divergence of the ion beam 34 to be measured. This may be done conveniently by dividing the shadowed part of the back plate 112 (i.e. that having a width greater than W₂ but less than W₃) into annular segments 120, 121 and inspecting the ion beam current measured by each segment. This information allows the divergence and parallelism of the ion beam 34 to be controlled.

The person skilled in the art will appreciate that variations may be made to the above described embodiments without departing from the scope of the invention defined by the appended claims.

For example, the number, shape and size of the segments 120, etc. may be varied according to need (including the relative shape and size of the segments). Also, the division of segments 120, etc. into parts may also be varied. The shape of the beam stop may also be varied, rectangular or square and round or elliptical being particularly preferred cross-sectional shapes.

1. A beam stop for an ion implanter comprising a charge collector with a segmented surface provided to receive an ion beam thereon, wherein the surface is divided into at least two segments, one segment extending around the other segment, and wherein each of the two segments is operable to provide one or more signals indicative of charge collected by that segment when an ion beam is incident thereon.

2. The beam stop of claim 1, wherein the surface is divided into at least two concentrically arranged segments.

3. The beam stop of claim 2, wherein the concentrically arranged segments include an annular segment.

4. The beam stop of claim 3, wherein the annular segment extends around a central circular segment.

5. The beam stop of claim 4, wherein the surface is divided into a central circular segment and a series of concentrically arranged annular segments.

6. The beam stop of claim 1, wherein one or more segments are further divided laterally and wherein each of the parts of the segment is operable to provide a signal indicative of charge collected by that division.

7. The beam stop of claim 6, wherein a segment is further divided laterally into halves.

8. The beam stop of claim 7, wherein a segment is further divided laterally into quarters.

9. An ion implanter comprising the beam stop of claim 1.

10. The ion implanter of claim 9, wherein the surface of the charge collector is divided into at least two concentrically arranged segments and wherein the ion implanter is operable to provide an ion beam having a shape corresponding to that of the segments when taken together.

11. The ion implanter of claim 10, wherein the ion implanter is operable to provide an ion beam with a circular transverse cross section and the surface is divided into a central circular segment and a series of concentrically arranged annular segments.

12. The ion implanter of claim 9, wherein the ion implanter further comprises a substrate holder for holding a substrate to be implanted in the ion beam's path upstream of the beam stop, the ion implanter is operable to cause relative motion of the ion beam and the substrate holder along a first direction, and wherein one or more segments of the beam stop are further divided transverse to the first direction with each of the halves so formed being operable to provide a signal indicative of charge collected by that half.

13. The ion implanter of claim 12, wherein the ion implanter is operable to cause relative motion of the ion beam and the substrate holder along a second direction, and wherein one or more segments of the beam stop are further divided transverse to the second direction with each of the quarters so formed being operable to provide a signal indicative of charge collected by that quarter.

14. The ion implanter of claim 9, further comprising an arithmetic unit operable to add the signals provided by the segments.

15. The ion implanter of claim 6, further comprising an arithmetic unit operable to add the signals provided by parts of the segments.

16. The ion implanter of claim 9, further comprising a controller operable to control ion optics to shape and/or steer the ion beam in response to signals provided by the segments.

17. A method of optimising an ion beam in an ion implanter according to claim 9, comprising shaping and/or steering the ion beam in response to signals provided by the segments of the beam stop.

18. A method of optimising an ion beam in an ion implanter according to claim 12, comprising shaping and/or steering the ion beam in response to signals provided by the segments of the beam stop and centring the ion beam using the signals provided by halves of the further divided segment of the beam stop.

19. The method of claim 18, comprising centring the ion beam by steering the ion beam until a required offset is achieved between the halves.

20. The method of claim 19, wherein the offset is zero.

21. A beam stop for an ion implanter comprising a front face defining an entrance aperture, an internal volume extending from the entrance aperture bounded by one or more sides and a back face, a charge collector with a surface forming at least part of the back face and being provided to receive an ion beam thereon, and a charge collecting baffle extending into the internal volume from one of the one or more sides and positioned forwards of the back face to present a forward face provided to receive an ion beam thereon, wherein the charge collector and the charge collecting baffle are each operable to provide one or more signals indicative of charge collected when an ion beam is incident on the surface and forward face respectively.

22. The beam stop of claim 21, wherein the baffle forms a neck in the internal volume.

23. The beam stop of claim 22, wherein a portion of the charge collector is shadowed by the baffle.

24. The beam stop of claim 22, wherein the baffle has a back face for collecting backscattered ions.

25. The beam stop of claim 21, wherein the baffle extends inwardly an equal distance from each of the one or more sides.

26. The beam stop of claim 21, comprising a pair of baffles disposed symmetrically across the internal volume.

27. The beam stop of claim 26, comprising four baffles disposed symmetrically around the internal volume.

28. The beam stop of claim 21, wherein the surface of the charge collector is segmented into at least two segments, one segment extending around the other segment, and wherein each of the two segments is operable to provide one or more signals indicative of charge collected by that segment when an ion beam is incident thereon.

29. The beam stop of claim 28, wherein the surface is divided into at least two concentrically arranged segments.

30. The beam stop of claim 29, wherein the concentrically arranged segments include an annular segment.

31. The beam stop of claim 30, wherein the annular segment extends around a central circular segment.

32. The beam stop of claim 31, wherein the surface is divided into a central circular segment and a series of concentrically arranged annular segments.

33. The beam stop of claim 28, wherein one or more segments are further divided laterally and wherein each of the parts of the segment is operable to provide a signal indicative of charge collected by that division.

34. The beam stop of claim 33, wherein a segment is further divided laterally into halves.

35. The beam stop of claim 34, wherein a segment is further divided laterally into quarters.

36. An ion implanter comprising the beam stop of claim 21.

37. The ion implanter of claim 36, further comprising an arithmetic unit operable to add the signals provided by the charge collector and the charge collecting baffle.

38. The ion implanter of claim 36, further comprising a controller operable to control ion optics to shape and/or steer the ion beam in response to signals provided by the charge collector and the charge collecting baffle.

39. A method of optimising an ion beam in an ion implanter according to claim 36, comprising shaping and/or steering the ion beam in response to signals provided by the charge collector and the charge collecting baffle.
